(19) United States
(12) Patent Application Publication
(10) Pub. No.: US 2011/0105665 A1
(43) Pub. Date: May 5, 2011

(54) METHODS FOR IMPROVING PHYSICAL PROPERTIES OF POLYESTERS

(75) Inventors: Paul M. Andrusyszyn, New Castle, DE (US); Hari Babu Sunkara, Hockessin, DE (US)

(73) Assignee: E. I. DU PONT DE NEMOURS AND COMPANY, Wilmington, DE (US)

(21) Appl. No.: 12/612,917

(22) Filed: Nov. 5, 2009

(51) Int. Cl. C08K 5/06; B29C 47/00; B29C 45/00

(52) U.S. Cl. 524/378; 264/176.1; 264/328.17

(57) ABSTRACT

Methods and compositions for improving certain physical properties of polyesters are provided. The compositions are based on poly(trimethylene ether)glycol, and can improve properties such as toughness and flexibility in polyesters, providing a balance of desired properties.

### RELATED APPLICATION

This application is related to commonly-owned U.S. Patent Application No. 61/051,136.

### FIELD OF THE INVENTION

This invention relates to polyester compositions containing poly(trimethylene ether)glycol, and to processes for making polymers containing the poly(trimethylene ether)glycol.

### BACKGROUND

Additives are substances which, when added to a polymeric material, alter the properties of that material in desired way. Examples of common additives include plasticizers, nucleating agents, toughening agents, thermal and oxidative stabilizers, inorganic and organic fillers, and so on.

Generally, plasticizers increase the flexibility and workability, brought about by a decrease in the glass-transition temperature, Tg, of the polymer. Commonly-used plasticizers include phthalates, including, for example, diisobutyl phthalate, dibutyl phthalate, and benzylbutyl phthalate; adipates, including di-2-ethylhexyl adipate; trimellitates, including tris-2-ethylhexyl trimellitate; and phosphates, including tris(2-ethylhexyl)phosphate. However, the use of some of these has been curtailed due to potential toxicity issues. Polyester plasticizers have also been used, but those have generally been based on condensation products of propanediol or butanediol with adipic acid or phthalic anhydride, and therefore may exhibit very high viscosities which subsequently cause processing problems in blending with other polymers. Plasticizers and processes are disclosed, for example, in D. F. Cadogan and C. J. Howick in Kirk-Othmer Encylclopedia of Chemical Technology, John Wiley and Sons, Inc., New York, Dec. 4, 2000, DOI: 10.1002/0471238961.1612011903010415.a01 and in the Handbook of Plasticizers; Edited by: Wypych, George; 2004 ChemTec Publishing; Chapter 11.

There is a desire to provide renewably sourced, non toxic and biodegradable materials as additives for natural polymers having improved or equivalent material properties to those provided by traditional, non-renewably sourced materials.

### SUMMARY OF THE INVENTION

One aspect of the present invention is a polyester composition comprising a physical blend of (i) about 70 to 99.0 weight of a polyester and (ii) about 1.0 to about 30 weight % poly(trimethylene ether)glycol mixture based on the total weight of the composition wherein the poly(trimethylene ether)glycol mixture comprises a blend of poly(trimethylene ether)glycol having a number average molecular weight ranging from 500 to 1800 and a number average molecular weight of 2000 to 5000.

Another aspect of the present invention is a poly (lactic acid) composition comprising a physical blend of (i) about 70 to 99.0 weight % of poly(lactic acid) and (ii) about 1.0 to about 30.0 weight % of poly(trimethylene ether)glycol, based on the total weight of the composition, wherein the poly(trimethylene ether)glycol has a number average molecular weight ranging from 1200 to 1800, and wherein the blend composition in a molded article has an elongation of more than 10%.

Another aspect of the present invention is a PLA composition comprising a physical blend of (i) about 70 to 99.0weight % of poly(lactic acid) and (ii) about 1.0 to about 30 weight % of poly(trimethylene ether)glycol, wherein the poly(trimethylene ether)glycol has a number average molecular weight ranging from 2000 to 5000, and wherein the blend composition in a molded article has a impact strength greater than 30 J/m and an elongation of more than 10%.

A further aspect of the present invention is a process for producing a polymer composition, comprising:
a. physically blending (i) about 70 to 99.0 weight % of poly(lactic acid) and (ii) about 1.0 to about 30.0 weight % of poly(trimethylene ether)glycol, based on the total weight of the composition, wherein the poly(trimethylene ether)glycol has a number average molecular weight ranging from 500 to 1800;
b. melt processing the poly(lactic acid) and poly(trimethylene ether)glycol at a temperature 20 to 40 degrees C. higher than the melt temperature of the poly(lactic acid)polymer to form a mixture; and
c. injection or extrusion molding the mixture from step (b) to form a molded article.

Another aspect of the present invention is a process for producing a polymer composition, comprising:
a. physically blending (i) about 70.0 to 99.0 weight % of poly(lactic acid) and (ii) about 1.0 to about 30.0 weight % of poly(trimethylene ether)glycol, based on the total weight of the composition, wherein the poly(trimethylene ether)glycol has a number average molecular weight within the range of 2000 to 5000;
b. melt processing the poly(lactic acid) and poly(trimethylene ether)glycol at a temperature 20 to 40 degrees C. higher than the melt temperature of the poly(lactic acid)polymer to form a mixture; and
c. injection or extrusion molding the mixture from step (b) to form a molded article.

These and other aspects of the present invention will be apparent to those skilled in the art in view of the following description and the appended claims.

### DETAILED DESCRIPTION

In the processes disclosed herein, poly(trimethylene ether)glycols are added to certain polyesters, herein referred to also as “base polymers”. Suitable base polymers include polyesters such as poly(lactic acid) (PLA), poly(3-hydroxy butyrate-co-valerate), polybutylene succinate, and poly(trimethylene terephthalate). A physical blend is made of about 70 to 99 weight % of the base polymer and about 1 to about 30 weight % of poly(trimethylene ether)glycol. The poly(trimethylene ether)glycol comprises poly(trimethylene ether)glycol having a number average molecular weight in the range 2000 to 5000 and/or poly(trimethylene ether)glycol having a number average molecular weight within the range of 500 to 1800.

Provided according to embodiments of the present invention is a polymer composition, comprising a physical blend of (i) about 70 to 99 weight % of a base polymer and (ii) about 1 to about 30 weight % of poly(trimethylene ether)glycol, wherein the poly(trimethylene ether)glycol has a number average molecular weight within the range of 2000 to 5000. Preferably the composition comprises about 80 to 99 weight % base polymer and about 1_to_{—}20%_ by weight poly(trimethylene ether)glycol, and more preferably, about 90_to 99 weight % base polymer and about 1_to 10 weight % poly(trimethylene ether)glycol having a number average molecular weight within the range of 2000 to 5000.

In other embodiments, the polymer composition comprises a physical blend of (i) about 70 to 99 weight % of a base polymer and (ii) about 1 to about 30 weight % of poly(trimethylene ether)glycol, wherein the poly(trimethylene ether)glycol has a number average molecular within the range of 500 to 1800. Preferably the composition comprises about 80 to 99 weight % base polymer and about 1 to 20% by weight poly(trimethylene ether)glycol, and more preferably, about 90 to_{—}99 weight % base polymer and about 1 to 10 weight % poly(trimethylene ether)glycol having a number average molecular weight within the range of 500 to 1800.

In other embodiments, the polymer composition comprises a physical blend of (i) about 70 to 99 weight % of a base polymer and (ii) about 1 to about 30 weight % of a poly(trimethylene ether)glycol mixture, wherein the poly(trimethylene ether)glycol mixture comprises poly(trimethylene ether)glycol having a number average molecular within the range of 500 to 1800 and poly(trimethylene ether)glycol having a molecular weight within the range of 2000 to 5000. The combined poly(trimethylene ether)glycol preferably comprise from about 0.5% to about 99.5 weight % poly(trimethylene ether)glycol having a number average molecular within the range of 500 to 1800 and from about 99.5 to about 0.5 weight % poly(trimethylene ether)glycol having a number average molecular weight within the range of 2000 to 5000.

In other embodiments, the polymer composition comprises a physical blend of (i) about 70 to 99 weight % of a polyester and (ii) about 1 to about 30 weight % poly(trimethylene ether)glycol mixture based on the total weight of the composition wherein the poly(trimethylene ether)glycol mixture comprises a blend of poly(trimethylene ether)glycol having a number average molecular weight within the range of 500 to 1800 and a number average molecular weight within the range of 2000 to 5000.

In some preferred embodiments, the polyester comprises poly(lactic acid) (PLA). In some preferred embodiments, the polyester is PLA.

In another embodiment, the polymer composition comprises a physical blend of (i) about 70 to 99 weight % of PLA and (ii) about 1 to about 30 weight % of poly(trimethylene ether)glycol, wherein the poly(trimethylene ether)glycol has a number average molecular weight within the range of 2000 to 5000 wherein the blend composition in a molded article has an impact strength greater than 30 J/m and elongation of more than 10%, more than 20% or even more than 30%.

In one embodiment, the composition comprises a physical blend of (i) about 70 to 99 weight % of PLA polymer and (ii) about 1 to about 30 weight % of poly(trimethylene ether)glycol, wherein the poly(trimethylene ether)glycol has a number average molecular weight within the range of 1200 to 1800 wherein the blend composition in a molded article has elongation more than 10%, more than 20% or even more than 30%. It is preferred that the modulus of PLA is not altered significantly by the presence of the poly(trimethylene ether glycol). “Not altered significantly”, as used herein with regard to alteration of the modulus of PLA means a change in modulus of less than 10 percent, preferably less than 8%.

Also provided, according to another embodiment, is a process for producing a polymer composition, comprising:
a. physically blending (i) about 70 to 99 weight % of base polymer and (ii) about 1 to about 30 weight % of poly(trimethylene ether)glycol, wherein the poly(trimethylene ether)glycol has a number average molecular weight within the range of 2000 to 5000
b. melt processing the base polymer and poly(trimethylene ether)glycol at a temperature 20 to 40° C. higher than the melt temperature of the base polymer to form a mixture; and

c. injection or extrusion molding the mixture from step (b) to form a molded article.

In some embodiments, the amount of base polymer is from about 80 to 99 weight % and the amount of poly(trimethylene ether)glycol is about 1 to 20 weight %.

In some preferred embodiments, the base polymer comprises PLA.

Also provided, according to another embodiment, is a process for producing a polymer composition, comprising:

a. physically blending (i) about 70 to 99 weight % of base polymer and (ii) about 1 to 30 weight % of poly(trimethylene ether)glycol, wherein the poly(trimethylene ether)glycol has a number average molecular weight within the range of 500 to 1800;

b. melt processing the base polymer and poly(trimethylene ether)glycol at a temperature 20 to 40 degrees C. higher than the melt temperature of the base polymer to form a mixture; and

c. injection or extrusion molding the mixture from step (b) to form a molded article.

In other embodiments, there is provided a process for producing a polymer composition, comprising:

a. physically blending (i) about 70 to 99 weight % of base polymer and (ii) about 1 to about 30 weight % of poly(trimethylene ether)glycol, wherein the poly(trimethylene ether)glycol comprises from about 0.5 to about 99.5 weight % of poly(trimethylene ether)glycol having a number average molecular weight within the range of 2000 to 5000 and from about 99.5 to about 0.5 weight % poly(trimethylene ether)glycol having a molecular weight within the range of 500 to 1800;

b. melt processing the base polymer and poly(trimethylene ether)glycol at a temperature 20 to 40° C. higher than the melt temperature of the base polymer to form a mixture; and

c. injection or extrusion molding the mixture from step (b) to form a molded article.

PLA is a preferred polyester for some embodiments of the present invention. PLA can be derived biologically from naturally occurring sources other than petroleum and is biodegradable. However, physical limitations such as brittleness and slow crystallization can cause difficulty during the injection molding of PLA into articles that have an acceptable degree of flexibility and toughness for many applications. Extruded amorphous sheeting may also be too brittle for handling in continuous moving equipment without breakage. Manufacturers and customers that use PLA to make a variety of articles are interested in improved injection molding processability and cycle times for articles made from PLA.

As used herein, the term poly(lactic acid) (“PLA”) refers to poly(lactic acid) homopolymers and copolymers of lactic acid and other monomers containing at least 50 mole % of repeat units derived from lactic acid or its derivatives, including mixtures of homopolymers and copolymers, having a number average molecular weight of 10,000 to 1,000,000, preferably 10,000-700,000 or more preferably 20,000 to 600,000. The poly(lactic acid) used can contain 70 mole % or more of repeat units derived from lactic acid or its derivatives. The poly(lactic acid) homopolymers and copolymers used can be derived from d-lactic acid, l-lactic acid, or a mixture thereof. A mixture of two or more poly(lactic acid) polymers can be used. Poly(lactic acid) is typically prepared by the catalyzed ring opening polymerization of the dimeric cyclic ester of lactic acid, which is referred to as “lactide”. As a result, poly(lactic acid) is also referred to as “polylactide”. Poly(lactic acid) may also be made by living organisms such as bacteria or isolated from plant mater that include corn, sweet potatoes, and the like.

In one embodiment, the polyester can be combined with poly(trimethylene ether)glycol. Both solid polyester and liquid poly(trimethylene ether)glycol are dried separately before combining. It is preferred that the water content of each of the polyester and the poly(trimethylene ether glycol) be less than 500 ppm. The dried solid polyester is then compounded with a desired amount of poly(trimethylene ether)glycol and is melt mixed and extruded so that the resulting blended composition has a poly(trimethylene ether)glycol content within the range of about 0.5 to about 20 weight %, although lower amounts such as about 1 to about 10 weight % can give desirable results such as, for example, higher crystallization rate and flexibility. Alternatively, a polyester master batch comprising up to 40 weight % of poly(trimethylene ether)glycol based on the total combined weight of the polyester and poly(trimethylene ether)glycol may be prepared and the master batch can be blended with neat polyester to obtain a poly(trimethylene ether)glycol content with in the desired range of about 1to 30l weight % in the polymer composition.

An article of manufacture such as a molded part or film may be prepared from the polyester/poly(trimethylene ether)glycol blended composition. Any molding process conventional in the plastics forming art including, for example, compression molding, injection molding, extrusion molding, blow molding, melt spinning and heat molding may be used. The polyester/poly(trimethylene ether)glycol blend compositions can be used in articles such as fibers, films for packaging and agricultural mulch, diapers, bags, tape and in paper coating.

### Poly(trimethylene ether)Glycol (PO3G)

Poly(trimethylene ether)glycols for use in the compositions and methods disclosed herein are oligomeric or polymeric ether glycols which are liquids at room temperature and have melting temperatures below 20° C. and glass transition temperature below −70° C.

Poly(trimethylene ether)glycol is preferably prepared by polycondensation of monomers comprising 1,3-propanediol, thus resulting in polymers or copolymers containing a —(CH₂CH₂CH₂O)— linkage (e.g, trimethylene ether repeating units). At least 50% of the repeating units in the polymer or copolymers are trimethylene ether units. More preferably from about 75% to 100%, still more preferably from about 90% to 100%, and even more preferably from about 99% to 100%, of the repeating units are trimethylene ether units.

In addition to the trimethylene ether units, lesser amounts of other units, such as other polyalkylene ether repeating units, may be present. In the context of this disclosure, the term “poly(trimethylene ether)glycol” encompasses PO3G made from 1,3-propanediol, as well as those oligomers and polymers (including those described below) containing up to about 50 weight % of comonomers. Comonomer polyols that are suitable for use in the processes and compositions disclosed herein include aliphatic diols, for example, ethylene glycol, 1,6-hexanediol, 1,7-heptanediol, 1,8-octanediol, 1,9-nonanediol, 1,10-decanediol, 1,12-dodecanediol, 3,3,4,4,5,5-hexafluro-1,5-pentanediol, 2,2,3,3,4,4,5,5-octafluoro-1,6-hexanediol, and 3,3,4,4,5,5,6,6,7,7,8,8,9,9,10,10-hexadecafluoro-1,12-dodecanediol; cycloaliphatic diols, for example, 1,4-cyclohexanediol, 1,4-cyclohexanedimethanol and isosorbide; and polyhydroxy compounds, for example, glycerol, trimethylolpropane, and pentaerythritol. A preferred group of comonomer diols is selected from the group consisting of ethylene glycol, 2-methyl-1,3-propanediol, 2,2-dimethyl-1,3-propanediol, 2,2-diethyl-1,3-propanediol, 2-ethyl-2-(hydroxymethyl)-1,3-propanediol, C₆-C₁₀ diols (such as 1,6-hexanediol, 1,8-octanediol and 1,10-decanediol) and isosorbide, and mixtures thereof. A particularly preferred diol other than 1,3-propanediol is ethylene glycol, and C₆-C₁₀ diols can be particularly useful as well.

One preferred copolyether glycol is poly(trimethylene-ethylene ether)glycol. Preferred poly(trimethylene-ethylene ether)glycols are prepared by acid catalyzed polycondensation of from 50 to about 99 mole % (preferably from about 60 to about 98 mole %, and more preferably from about 70 to about 98 mole %) 1,3-propanediol and 50 to about 1 mole % (preferably from about 40 to about 2 mole %, and more preferably from about 30 to about 2 mole %) ethylene glycol.

The 1,3-propanediol employed for preparing the poly(trimethylene ether)glycols may be obtained by any of the various well known chemical routes or by biochemical transformation routes. Preferred routes are described in, for example, US20050069997A1.

Preferably, the 1,3-propanediol is obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. Thus, the compositions of the present invention can be characterized as more natural and having less environmental impact than similar compositions comprising petroleum based glycols.

The biologically-derived 1,3-propanediol based poly(trimethylene ether)glycol may be distinguished from similar compounds produced from a petrochemical source or from fossil fuel carbon by dual carbon-isotopic finger printing. This method usefully distinguishes chemically-identical materials, and apportions carbon in the copolymer by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2942 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated %, and are calculated as follows:

$${δ}^{13} C ≡ \frac{{(}^{13} C {/}^{12} C ) sample - {(}^{13} C {/}^{12} C ) standard}{{(}^{13} C {/}^{12} C ) standard} \times 1000 \%$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Renewably sourced PO3G polymers with number average molecular weights 650, 1000, 1400, 2000 and 2400 are available under the trade name Cerenol® polyols from DuPont. Molecular weights may be recited herein as, for example “650±50” to indicate a distribution of molecular weights around, for example, 650, wherein the distribution is from about 600 to about 700, with a maximum at 650. When the shorthand molecular weight is written herein without the “±” designation, it is intended that the distribution be understood unless otherwise indicated.

It has been found that the blending of poly(trimethylene ether)glycol with polyesters can provide unexpected advantages. In particular, the effect of the amount and the molecular weight of poly(trimethylene ether)glycol on PLA performance when the PLA and poly(trimethylene ether)glycol are physically blended is surprising. It has further been surprisingly found that the particular molecular weight of the poly(trimethylene ether)glycol blended with the PLA can affect the nature and degree of physical property improvements, allowing for control of the improvements. When poly(trimethylene ether)glycol having a number average molecular weight 650±50 is blended with PLA, the following properties of PLA are affected: With an increase in the amount of poly(trimethylene ether)glycol from 0 to 10 wt %, the PLA viscosity and glass transition temperatures are decreased progressively. Decrease in viscosity improves the processability. When the amount of poly(trimethylene ether)glycol is relatively low (e.g., 2.5wt %), the tensile strength of PLA increases and its elongation decreases, which makes the PLA more brittle than flexible. Even at 10 wt % poly(trimethylene ether)glycol while a slight improvement was observed in the elongation, hardness, impact strength of the PLA, the degree of crystallization was significantly higher than that of neat PLA.

When poly(trimethylene ether)glycol having a number average molecular weight 1400±100 is blended with PLA, the stretchability of the PLA is higher than that observed when poly(trimethylene ether)glycol of Mn 650±50 is used.

On the other hand the effect on the physical properties of PLA by poly(trimethylene ether)glycol having number average molecular weight 2400 is much different than that of poly(trimethylene ether)glycol having number average molecular weights of 650 and 1400. The 2400 molecular weight poly(trimethylene ether)glycol does not decrease the glass transition temperature of PLA as much the poly(trimethylene ether)glycol having molecular weights of 650 and 1400. The 2400 molecular weight poly(trimethylene ether)glycol has no measurable impact on the degree of crystallization. Nonetheless the 2400 molecular weight poly(trimethylene ether)glycol has significant impact on impact strength and percent elongation of PLA, both properties increasing with increased amount of polyol, and thus the 2400 molecular weight poly(trimethylene ether)glycol acts as impact modifier. Therefore, the molecular weight and quantity of the poly(trimethylene ether)glycol can be selected to maximize the performance of PLA.

If, for example, the poly(trimethylene ether)glycol molecular weight is higher than 2000, both flexibility and impact strength of PLA can be improved without affecting the glass transition temperature significantly.

The preferred poly(trimethylene ether)glycol for use in some embodiments disclosed herein has a Mn number average molecular weight from about 2000 to about 5000, more preferably from about 2000 to about 3000. More particularly, it is highly preferred that the poly(trimethylene ether)glycol molecular weight is 2000 or greater to effect more significant improvements in terms of flexibility of PLA.

As a specific example, addition to PLA of poly(trimethylene ether)glycol having a relatively low molecular weight, e.g., about 650, provides the following effects: it improves processability by progressively lowering the viscosity as the amount increases from 0 to 10%; it decreases the glass transition temperature and thereby increases the degree of crystallinity at a content of 10 weight %; at relatively small quantities it increases the tensile strength while decreasing elongation (i.e., functions as an antiplasticizer); it causes no decrease in hardness and modulus and no increase in elongation with increased amount (i.e., no plasticization); and it causes no change in melt temperature, impact strength or tear strength.

The addition to PLA of poly(trimethylene ether)glycol having a molecular weight of about 1400 provides the following effects: it improves processability by lowering the viscosity as the amount increases from 0 to weight 10%; it decreases the glass transition temperature; it increases the degree of crystallinity at a content of 10%; it increases elongation (stretchability); it causes no decrease in hardness, tensile modulus, storage modulus, or flexural modulus; and it causes no change in melt temperature, impact strength or tear strength. This molecular weight poly(trimethylene ether)glycol thus functions generally as a plasticizer.

When added to PLA, poly(trimethylene ether)glycol having a molecular weight of about 2400 generally functions as modifier/extender/processing oil and provides the following effects: it increases the processability of the PLA; it does not decrease the glass transition temperature; it does not increase the degree of crystallinity; it improves elongation; it decreases hardness; it increases impact strength (toughness) at a content of 10 weight %; it increases the tear strength of the film at a content of 2.5 weight %; and it is resistant to extraction and migration.

The compositions and processes disclosed herein can be used advantageously to prepare polymer compositions by blending PLA with a mixture of poly(trimethylene ether)glycols with different molecular weights to obtain tailor made properties. For example, to obtain a PLA composition with improved impact strength and high degree of crystallization, a polyol having 1400 molecular weight may be mixed with a 2400 molecular weight.

The methods and compositions disclosed herein can be extended to the preparation of polymer compositions by blending PLA with a mixture of poly(trimethylene ether)glycols with different molecular weights to obtain tailor made properties. For example, to obtain a PLA composition having improved impact strength and an increased degree of crystallization, a poly(trimethylene ether)glycol having a molecular weight of 1400 molecular weight can be mixed with a poly(trimethylene ether)glycol having a molecular weight of 2400, for blending with the PLA.

Poly(trimethylene ether)glycols preferred for use in the processes and compositions disclosed herein are typically polydisperse, having a polydispersity (i.e. Mw/Mn) of from about 1.2 to about 2.2, more preferably from about 1.2 to about 2.0, and still more preferably from about 1.5 to about 1.9.

The poly(trimethylene ether)glycols can be blended with other known additives such as plasticizers including but not limited to synthetic and natural esters. Natural esters include vegetable based triglyceride oils such as soybean, sunflower, rapeseed, palm, canola, and castor oils. Preferred vegetable oils include castor oil, high oleic soybean oil and high oleic sunflower oil.

The poly(trimethylene ether)glycol can be added to a polyester using any convenient method known to the skilled artisan. Generally, the poly(trimethylene ether)glycol is blended with the polyester in a mixer, and then mixed at a temperature 20 to 40° C. above the melting temperature of the polymer, although the preferred mixing temperature is dependent on the melt temperature of the polyester. After the polyester and poly(trimethylene ether) glycol are mixed (generally, less than about 20 minutes, 15, 10, or 5 minutes, dependent on the materials being mixed) the mixture is cooled to room temperature. Liquid nitrogen is generally used to further cool the base polymer mixture so that the modified polyester can be easily ground into particles, if desired. Any grinding procedure can be used, and the polyester/poly(trimethylene ether)glycol material is generally ground to particle sizes of about 0.1 to 10 mm, or any size that will allow further processing. Once the material is ground, then it is dried at a slightly elevated temperature (generally 80-95° C.) under an inert atmosphere (generally in a vacuum oven or under a small quantity of inert gas or rarified air). The dried, ground material can then be further processed to form the desired product. The processing can take place in an extruder, or press mold, for example.

After the material has been processed, the composition can be tested by a variety of methods, including tensile, elongation, toughness and tear strengths at given temperature, surface characteristics (feel or “hand” and resistance to soiling and staining), and pliability at given temperatures (Durometer hardness and bending properties). Various test methods are commonly used, including ASTM D790-07E1, ASTM D638-08, ASTM D1004-09, ASTM D256-06AE1, ASTM F1249-06, ASTM D2240-05, ASTM D1708-06a

### EXAMPLES

The present invention is further illustrated by the following examples. These examples, while indicating preferred embodiments of the invention, are presented by way of illustration only. From the above discussion and these examples, one skilled in the art can ascertain the essential characteristics of this invention, and without departing from the spirit and scope thereof, can make various changes and modifications of the invention to adapt it to various usages and conditions.

Poly(trimethylene ether)glycols (PO3G) with various molecular weights are available as Cerenol® H650, Cerenol® H1400 and Cerenol® 2400 polyols from DuPont, Wilmington, Del.

Poly(lactic acid) (PLA2002D) (PLA) is available from NatureWorks LLC, Minnetonka, Minn.

Phase transition temperatures of the polymer blends were measured using differential scanning calorimetry (DSC) by heating the samples from −90° C. to 250° C. at 10° C./minute. All data was taken from the second heat cycle. DSC is a thermal analysis technique that measures heat flow into or out of material as a function of time or temperature.

The recrystallization half-times (t_{1/2}) for the polymers were measured using Perkin-Elmer DSC-7 by heating the samples at 200° C./min rate to a crystallizable temperature. The samples were held at the temperature till crystallization was completed.

Dynamic Mechanical Analysis (DMA) were carried out using test bars of width 12.5 mm, thickness 2-2.7 mm mounted in TA Instruments 8-mm dual cantilever flexural clamp jaws. The flexural mode was set up in 10 μm oscillation amplitude, 1 Hz frequency, and heating rate of 2° C./min from −140° C. to 100° C.

All parts, percentages, etc., are by weight unless otherwise indicated.

Unless otherwise stated, the following standard test methods were used in the Examples and are the basis of the values presented for the following measurable properties hereinabove.
ASTM D790-07E1: Standard Test Methods for Flexural Properties of Unreinforced and Reinforced Plastics and Electrical Insulating Materials
ASTM D638-08: Standard Test Method for Tensile Properties of Plastics
ASTM D1004-09: Standard Test Method for Tear Resistance (Graves Tear) of Plastic Film and Sheeting
ASTM D256-06AE1: Standard Test Methods for Determining the Izod Pendulum Impact Resistance of Plastics
ASTM F1249-06: Standard Test Method for Water Vapor Transmission Rate through a plastic film or sheet using an infrared sensor.
ASTM D2240-05: Standard Test Method for Rubber Property—Durometer Hardness
ASTM D1708-06a: Standard Test Method for Tensile Properties of Plastics by Use of Microtensile Specimens.

### Comparative Example A, and Examples 1-9

The following examples i the use of poly(trimethylene ether)glycol homopolymer as an additive to improve the properties of poly(lactic acid) (PLA).

NatureWorks® PLA 2002D polymer was dried in a vacuum oven at 90-95° C. for ˜18 hours prior to compounding extrusion and was maintained in a moisture-free environment until processing was complete. NatureWorks® PLA polymer was each compound extruded with Cerenol® H650, H1400 and H2400 polyols in a Werner and Pfleiderer ZSK-30 co-rotating twin screw extruder at a processing temperature of 180° C. and 250° C., respectively, and a rotational speed of 200 rpm. The extruder had 13 barrels and the 30 mm diameter screws consisted of elements that allowed for the kneading and conveying of the mixture with a L/D ratio of 32. The Cerenol® polyol was added as a liquid by a displacement pump into the middle of the extruder barrel, downstream of the polymer addition. The total rate of compounded polymer produced was 30 lbs/hr, and the rates of the two materials were adjusted to give the various compositions and described in Table 1 below. As the molten polymer strand exited the extruder, it was submerged into a cold water bath. Once the polymer had cooled, the excess water was removed and the strand was cut to form pellets.

TABLE 1

| | | | Feed | Feed | |
|---|---|---|---|---|---|
| | | | Rate | Rate of | |
| | | | of Base | Cerenol ® | wt % |
| | | Cerenol ® | Polymer | polyol | Cerenol ® |
| Example | Base Polymer | polyol | (lbs/hr) | (lbs/hr) | polyol |
| A (comp) | Polylactide | None | 30.00 | 0.00 | 0.0% |
| | PLA 2002D | | | | |
| 1 | Polylactide | H1400 | 29.25 | 0.75 | 2.5% |
| | PLA 2002D | | | | |
| 2 | Polylactide | H1400 | 28.50 | 1.50 | 5.0% |
| | PLA 2002D | | | | |
| 3 | Polylactide | H1400 | 27.00 | 3.00 | 10.0% |
| | PLA 2002D | | | | |
| 4 | Polylactide | H2400 | 29.25 | 0.75 | 2.5% |
| | PLA 2002D | | | | |
| 5 | Polylactide | H2400 | 28.50 | 1.50 | 5.0% |
| | PLA 2002D | | | | |
| 6 | Polylactide | H2400 | 27.00 | 3.00 | 10.0% |
| | PLA 2002D | | | | |
| 7 | Polylactide | H650 | 29.25 | 0.75 | 2.5% |
| | PLA 2002D | | | | |
| 8 | Polylactide | H650 | 28.50 | 1.50 | 5.0% |
| | PLA 2002D | | | | |
| 9 | Polylactide | H650 | 27.00 | 3.00 | 10.0% |
| | PLA 2002D | | | | |

The compounded materials were dried in a vacuum oven at 90-95° C. for ˜18 hours prior to injection molding or film extrusion and were maintain in a moisture-free environment until processing was complete. The materials were molded into ASTM ⅛″ thick tensile and flexural test bars with an Arburg 221 KS-350-100 Allrounder single screw injection molding machine. The injection molder, serial #: 189537 had a ⅛″ nozzle orifice, a 38 ton pressure capability, and a general purpose plasticizing screw with a diameter of 25 mm and a L/D ratio of 30. The injection molding conditions for the PLA based materials used an injection temperature of 225° C. and a mold temperature of 30° C.

TABLE 2

| | Cerenol ® | | Melt | | | Phase Transition | | | |
|---|---|---|---|---|---|---|---|---|---|
| | H1400 | | flow | | | Temperatures | | | |
| | polyol, | IV, | index | | | Tg | Tc | Tm | ΔH |
| Example | wt % | dL/g | g/10 min | Mw | Mw/Mn | (° C.) | (° C.) | (° C.) | (J/g) |
| A (comp) | PLA + 0 | 1.462 | 3.35 | 248190 | 1.56 | 58.5 | none | 149.5 | 0.1 |
| 1 | PLA + 2.5 | 1.439 | | 238580 | 1.82 | 53.8 | 125.7 | 149.6 | 1.1 |
| 2 | PLA + 5.0 | 1.406 | | 235190 | 2.14 | 50.2 | 125.2 | 148.3 | 8.1 |
| 3 | PLA + 10 | 1.339 | 10.2 | 221770 | 2.55 | 43.6 | 110.3 | 149.7 | 30.4 |

TABLE 3

| | Cerenol ® | | | | Phase Transition | | | |
|---|---|---|---|---|---|---|---|---|
| | H650 | | | | Temperatures | | | |
| Exam- | polyol, | IV, | | Mw/ | Tg | Tc | Tm | ΔH |
| ple | wt % | dL/g | Mw | Mn | (° C.) | (° C.) | (° C.) | (J/g) |
| A | PLA + 0 | 1.462 | 248190 | 1.56 | 58.5 | none | 149.5 | 0.1 |
| (comp) | | | | | | | | |
| 7 | PLA + 2.5 | 1.346 | 277065 | 2.29 | 53.2 | 125.4 | 149.4 | 0.2 |
| 8 | PLA + 5.0 | 1.320 | 265779 | 3.23 | 47.5 | 124.5 | 147.3 | 5.6 |
| 9 | PLA + 10 | 1.269 | 255528 | 4.45 | 43.0 | 108.9 | 148.4 | 25.7 |

TABLE 4

| | Cerenol ® | | | | Phase Transition | | | |
|---|---|---|---|---|---|---|---|---|
| | H2400 | | | | Temperatures | | | |
| Exam- | polyol, | IV, | | Mw/ | Tg | Tc | Tm | ΔH |
| ple | wt % | dL/g | Mw | Mn | (° C.) | (° C.) | (° C.) | (J/g) |
| A | PLA + 0 | 1.462 | 248190 | 1.56 | 58.5 | none | 149.5 | 0.1 |
| (comp) | | | | | | | | |
| 4 | PLA + 2.5 | 1.355 | 273639 | 1.85 | 56.9 | 127.0 | 149.6 | 1.4 |
| 5 | PLA + 5.0 | 1.333 | 267172 | 2.14 | 56.4 | 128.0 | 149.4 | 2.5 |
| 6 | PLA + 10 | 1.279 | 251833 | 2.58 | 55.3 | 125.9 | 148.1 | 6.8 |

As shown in Table 2 and 3, as the amount of Cerenol® H1400 and Cerenol® H650 polyol in PLA increased from 0 to 10 wt %, the polymer intrinsic viscosity (IV), glass transition temperature (Tg), and cold crystallization temperature (Tc) were all decreased progressively. Nonetheless, the polymer melt temperature (Tm) was not affected. A lower crystallization temperature on heating indicates faster crystallization. The enthalpy (ΔH), the amount of energy absorbed/released during crystal growth or melting (joules) divided by the sample mass (grams), was also observed to increase with increased amount of Cerenol® polyol suggesting an increased degree of crystallinity. Thus Cerenol® H650 and H1400 polyols appear to be functioning as plasticizers. However, the effect of Cerenol® H2400 polyol on PLA properties was quite different from that of Cerenol® H1400 and H650 polyols, as shown in Table 4. The extent of decrease in glass transition temperature with Cerenol® H2400 polyol was much smaller and therefore the impact of Cerenol® H2400 polyol on the rate of crystallization is insignificant.

TABLE 5

| Tem- | | | |
|---|---|---|---|
| perature | Half Time Crystallization | | |
| ° C. | Example 1 | Example 2 | Example 3 |
| 90 | | 0.28 min (11.2 J/g) | 0.32 min (14.4 J/g) |
| | | 4.9 min (5.7 J/g) | 4.3 min (8.3 J/g) |
| 100 | 0.3 min (7.8 J/g) | 0.32 min (10.9 J/g) | 0.30 min (9.3 J/g) |
| | 4.3 min (12 J/g) | 2.8 min (5.3 J/g) | 2.3 min (4.2 J/g) |
| 105 | | 0.30 min (13.4 J/g) | |
| | | 2.4 min (4 J/g) | |
| 110 | 0.38 min (10 J/g) | 0.30 min (11.9 J/g) | 0.25 min (12.1 J/g) |
| | 1.95 min (0.08 J/g) | 2.5 min (4.1 J/g) | 2.4 min (3 J/g) |
| 120 | 0.33 min (15 J/g) | 0.28 min (9.6 J/g) | 0.37 min (13.1 J/g) |
| | 2.7 min (0.7 J/g) | 4.4 min (1.4 J/g) | 4.2 min (3.8 J/g) |

As shown in Table 5, PLA has two crystal modifications in the presence of Cerenol® H1400 polyol, and one of the modifications crystallizes faster than the other by an order of magnitude. The lower the t_{1/2} value, the faster the crystallization rate. The minimum t_{1/2} value for the faster rate of crystallization is about 0.25 minutes at 110° C., whereas the minimum t_{1/2} value for the slower rate of crystallization rate is 1.95 minutes at 110° C. The base PLA polymer was not tested. Overall, an increased amount of Cerenol® H1400 polyol had no significant effect on rate of crystallization.

TABLE 6
Properties of injection molded samples of PLA/Cerenol ® H1400 polyol

| | Cerenol ® | | Storage | | Tensile | | | | |
|---|---|---|---|---|---|---|---|---|---|
| | H1400 | | modulus | Tensile | at | | Flexural | Flexural | Izod |
| | polyol | Hardness | @ 25 C. | modulus | break | Elongation | strength | modulus | impact |
| Example | wt % | Shore D | Mpa | MPa | MPa | at break % | MPa | MPa | J/m |
| A | 0 | 88 | 3064 | 3686 | 55.4 | 5 | 112 | 3813 | 26.1 |
| (comp) | | | | | | | | | |
| 1 | 2.5 | 88 | 2945 | 3666 | 32.1 | 20 | 80 | 3679 | 27.4 |
| 2 | 5.0 | 88 | 2951 | 3459 | 24.8 | 135 | 54 | 3468 | 28.5 |

Surprisingly, Cerenol® H1400 polyol, when present in small quantities, improved the percent elongation (flexibility) of the PLA significantly while retaining most of the mechanical properties. Interestingly, there were no significant changes in hardness, storage, tensile and flexural moduli, and impact strength. On the other hand Cerenol® 650 polyol was observed to have no impact on polymer flexibility (Table 7) which suggests that PLA containing Cerenol® 650 polyol may be as brittle as neat PLA.

TABLE 7
Properties of PLA/Cerenol ® H650

| | Cerenol ® | | Storage | | Tensile | | | | |
|---|---|---|---|---|---|---|---|---|---|
| | H650 | | modulus | Tensile | at | | Flexural | Flexural | Izod |
| | polyol | Hardness | @ 25 C. | modulus | break | Elongation | strength | modulus | impact |
| Example | wt % | Shore D | Mpa | MPa | MPa | at break % | MPa | MPa | J/m |
| A | PLA + 0 | 88 | 3064 | 3686 | 55.4 | 5 | 112 | 3813 | 26.1 |
| (comp) | | | | | | | | | |
| 7 | PLA + | 89 | 3040 | 3380 | 56.9 | 2 | 90 | 3596 | 28.6 |
| | 2.5 | | | | | | | | |
| 8 | PLA + | 86 | 3073 | 3350 | 50.7 | 2 | 77 | 3475 | 27.9 |
| | 5.0 | | | | | | | | |
| 9 | PLA + 10 | 85 | 2830 | 2882 | 27.7 | 8 | 62 | 3035 | 31.7 |

TABLE 8
Properties of injection molded samples of PLA/Cerenol ® H2400

| | Cerenol ® | | Storage | | Tensile | | | | |
|---|---|---|---|---|---|---|---|---|---|
| | H650 | | modulus | Tensile | at | | Flexural | Flexural | Izod |
| | polyol | Hardness | @ 25 C. | modulus | break | Elongation | strength | modulus | impact |
| Example | wt % | Shore D | Mpa | MPa | MPa | at break % | MPa | MPa | J/m |
| A | PLA + 0 | 88 | 3064 | 3686 | 55.4 | 5 | 112 | 3813 | 26.1 |
| (comp) | | | | | | | | | |
| 4 | PLA + | 88 | 3099 | 3276 | 30.4 | 76 | 62 | 3581 | 30.7 |
| | 2.5 | | | | | | | | |
| 5 | PLA + | 86 | 2988 | 3239 | 30.6 | 98 | 52 | 3431 | 35.0 |
| | 5.0 | | | | | | | | |
| 6 | PLA + 10 | 80 | 2770 | 3289 | 21.3 | 104 | 44 | 3112 | 48.7 |

The properties of PLA in the presence of Cerenol® H2400 polyol are rather interesting and surprising because Cerenol® H2400 not only improved the flexibility but also improved the toughness of PLA. At 10 wt % of Cerenol® H2400 polyol, the impact strength of the PLA was increased by more than 85%.

### Comparative Example A1 and Examples 10-12

The PLA polymer and polymer blends listed in Table 9 were extruded into film using a twin screw Werner & Pfleiderer extruder equipped with a 28 mm diameter barrel having a 29:1 L/D ratio, 6 barrel segments, a medium mixing screw and a coat hanger style 10 inch slit die with a variable opening. The extruder was operated at 175° C. and 150 rpm. The opening was adjusted to produce film that was nominally 5 mils in thickness. As the film was continuously extruded, it was cooled to 20° C. on a water cooled 10 inch diameter stainless steel casting drum and wound onto the take-up roll at 4 feet per minute. The measured film properties are listed.

TABLE 9
Properties of Extruded Film

| | | | | | | Moisture |
|---|---|---|---|---|---|---|
| | | | | | | Vapor |
| | | Tensile | | | Tear | Transmission |
| | | modulus | Tensile at | Elongation | resistance | Rate (g · mil)/ |
| Example | PLA/Cerenol ® polyol | MPa | break MPa | at break % | N/mm | (m² · day) |
| A1 (comp) | PLA + 0% Cerenol ® polyol | 2446 | 56.7 | 5.1 | 199 | 350 |
| 10 | PLA + 10% Cerenol ® H650 | 2147 | 41.5 | 8.3 | 200 | 610 |
| | polyol | | | | | |
| 11 | PLA + 5% Cerenol ® H1400 | 2125 | 34.9 | 11.8 | 198 | 473 |
| | polyol | | | | | |
| 12 | PLA + 2.5% Cerenol ® | 2315 | 31.7 | 43.4 | 242 | 409 |
| | H2400 polyol | | | | | |

The properties of PLA film containing only 2.5 wt % of Cerenol® H2400 polyol were superior in terms of elongation and tear strength, and good barrier properties, and in particular the tear strength of the flexible film was more than 20% higher than the film without Cerenol® polyol

### Examples 13 and 14

The PLA blends were prepared by adding the dried PLA and 5 wt % of poly(trimethylene ether)glycol having two different molecular weights (50/50 by weight) (as shown in Table 10) to a Brabender batch mixer operating at 190° C. and 50 RPM and allowing the materials to blend for 5 minutes. After thorough mixing, the polymer blends were removed from the Brabender and allowed to cool to room temperature, ground into pellets and compression molded into sheets for tensile testing and the properties of the blends are shown in Table 10.

TABLE 10
Properties of PLA and a 50/50 mixture of poly (trimethylene ether)
glycols of two different molecular weights

| | |
|---|---|
| | Phase |
| Quantity of | Transition Temperatures |

| | Cerenol ® | Tg | Tc | Tm | ΔH |
|---|---|---|---|---|---|
| Example | wt % | (° C.) | (° C.) | (° C.) | (J/g) |
| 13 | PLA + 2.5% | 53.1 | 125.9 | 148.7 | 4.2 |
| | Cerenol ® | | | | |
| | H650 + 2.5% | | | | |
| | Cerenol ® | | | | |
| | H2400 polyol | | | | |
| 14 | PLA + 2.5% | 55.6 | 126.6 | 149.7 | 1.9 |
| | Cerenol ® | | | | |
| | H1400 + 2.5% | | | | |
| | Cerenol ® | | | | |
| | H2400 polyol | | | | |

What is claimed is:

1. A polyester composition comprising a physical blend of (i) about 70 to 99.0 weight of a polyester and (ii) about 1.0 to about 30 weight % poly(trimethylene ether)glycol mixture based on the total weight of the composition wherein the poly(trimethylene ether)glycol mixture comprises a blend of poly(trimethylene ether)glycols having a number average molecular weight ranging from 500 to 1800 and a number average molecular weight of 2000 to 5000.

2. The polyester composition of claim 1 wherein the polyester is selected from the group consisting of poly(lactic acid), poly(3-hydroxy butyrate-co-valerate), polybutylene succinate, and poly(trimethylene terephthalate).

3. The polyester composition of claim 1 wherein the polytrimethylene ether glycol mixture comprises (1) 0.05 to 99.5% by weight of polytrimethylene ether glycol having a number average molecular weight within the range of 500 to 1800 and (ii) 99.5 to 0.05% by weight of poly(trimethylene ether)glycol having a number average molecular weight within the range of 2000 to 5000.

4. A poly(lactic acid) composition comprising a physical blend of (i) about 70 to 99.0 weight % of poly(lactic acid) and (ii) about 1.0 to about 30.0 weight % of poly(trimethylene ether)glycol, based on the total weight of the composition, wherein the poly(trimethylene ether)glycol has a number average molecular weight ranging from 1200 to 1800, and wherein the blend composition in a molded article has an elongation of more than 10%.

5. A poly(lactic acid) composition comprising a physical blend of (i) about 70 to 99.0 weight % of poly(lactic acid) and (ii) about 1.0 to about 30 weight % of poly(trimethylene ether)glycol, wherein the poly(trimethylene ether)glycol has a number average molecular weight ranging from 2000 to 5000, and wherein the blend composition in a molded article has a impact strength greater than 30 J/m and an elongation of more than 10%.

6. A process for producing a polymer composition, comprising:
a. physically blending (i) about 70.0 to 99.0 weight % of poly(lactic acid) and (ii) about 1.0 to about 30.0 weight % of poly(trimethylene ether)glycol, based on the total weight of the composition, wherein the poly(trimethylene ether)glycol has a number average molecular weight within the range of 500 to 1800;
b. melt processing the poly(lactic acid) and poly(trimethylene ether)glycol at a temperature 20 to 40 degrees C. higher than the melt temperature of the poly(lactic acid)polymer to form a mixture; and
c. injection or extrusion molding the mixture from step (b) to form a molded article.

7. A process for producing a polymer composition, comprising:
a. physically blending (i) about 70.0 to 99.0 weight % of poly(lactic acid) and (ii) about 1.0 to about 30 weight % of poly(trimethylene ether)glycol, based on the total weight of the composition, wherein the poly(trimethylene ether)glycol has a number average molecular weight within the range of 2000 to 5000;
b. melt processing the poly(lactic acid) and poly(trimethylene ether)glycol at a temperature 20 to 40 degrees C. higher than the melt temperature of the poly(lactic acid)polymer to form a mixture; and
c. injection or extrusion molding the mixture from step (b) to form a molded article.

8. A molded article comprising a composition of claim 1.

9. A molded article comprising a composition of claim 4.

10. The composition of claim 1 wherein at least one of the polyester and the poly(trimethylene ether glycol) is renewably sourced.

11. The composition of claim 4 wherein at least one of the poly(lactic acid) and the poly(trimethylene ether glycol) is renewably sourced.

12. A film comprising a composition of claim 1.

13. A film comprising a composition of claim 4.
